(19) United States
(12) Patent Application Publication
(10) Pub. No.: US 2006/0074144 A1
(43) Pub. Date: Apr. 6, 2006

(54) water-based ink for stencil printing and stencil printing method

(76) Inventors: Yoshifumi Watanabe, Ibaraki-ken (JP); Yoshihiro Hayashi, Ibaraki-ken (JP); Hiroshi Hayashi, Ibaraki-ken (JP)

Correspondence Address: NATH & ASSOCIATES, 112 South West Street, Alexandria, VA, 22314, US

(21) Appl. No.: 11/242,930

(22) Filed: Oct. 5, 2005

(30) Foreign Application Priority Data
Oct. 6, 2004 (JP) P2004-294173

(51) Int. Cl. C03C 17/00; C09D 11/00

(52) U.S. Cl. 523/160; 523/161

(57) ABSTRACT

A water-based ink for stencil printing that includes a copolymer of an unsaturated carboxylic acid as a first monomer, and a second monomer selected from the group consisting of vinyl amide-based monomers, vinyl ether-based monomers, and hydroxyl group-containing (meth)acrylate ester-based monomers, as well as a stencil printing method that uses such an ink.

### CROSS REFERENCE TO RELATED APPLICATIONS

This Application is based upon and claims the benefit of priority from prior Japanese Application P2004-294173 filed on Oct. 6, 2004; the entire contents of which are incorporated by reference herein.

### BACKGROUND OF THE INVENTION

1. Field of the Invention

The present invention relates to a water-based ink for stencil printing, and more particularly to a water-based ink for stencil printing that is suitable for use in a rotary digital stencil printing machine, as well as a stencil printing method that uses such an ink.

2. Description of the Related Art

Compared with other printing methods such as offset printing, gravure printing, and letterpress printing, stencil printing offers significant advantages in terms of operability and convenience, including not requiring complex operations such as post-use cleaning operations, and not requiring a specialist operator. Since the introduction of thermal stencil making methods that use a thermal printing head as a perforation device, image processing within stencil printing methods has been able to be digitalized, enabling high quality printed products to be produced quickly and with comparative ease, and consequently the convenience of stencil printing continues to gain recognition, even as a method for information processing terminals.

Rotary stencil printing machines, in which the making, loading, and removal operations for the stencil master, as well as the ink supply operation and the printing operation are all controlled automatically, are widely used in offices and schools under names such as digital stencil duplicators.

Inks for stencil printing have conventionally been water-in-oil (W/O) emulsion inks. W/O emulsion inks have a function that inhibits variations in the ink composition or the ink properties when the printing machine is sitting unused, even if the ink inside the machine is in contact with the atmosphere. In other words, the water, which is the inner phase component of the emulsion ink, is covered with the outer phase oil component, meaning evaporation of the water is inhibited.

It is thought that the drying of printed material that has been printed using a W/O emulsion ink proceeds by a mechanism that relies on the penetration of the ink into the gaps between the fibers of the paper that functions as the print target (the print medium), and the gradual separation of the ink into an oil phase and a water phase as a result of contact with the paper fibers, thus enabling the water, which represents the major component of the ink, to contact the atmosphere and evaporate. However, the water within the ink transferred to the print medium is unable to undergo adequate contact with the atmosphere in the short period of time following printing, meaning the drying characteristics immediately following printing rely on drying by penetration. However, because the viscosity of a W/O emulsion ink is designed to be relatively high, the rate of penetration is not particularly fast, meaning the drying characteristics of the ink immediately following printing are not entirely satisfactory.

Improving the drying rate of printed material is an extremely important problem for stencil printing. If the printed material is not dry, the operator is unable to handle the material, and the advantage of stencil printing of “producing high quality printed material in a short time” is partially negated.

Due to their improved environmental friendliness and safety, water-based inks for stencil printing have also been developed, and a stencil printing method in which a base is applied to the printed surface immediately following printing, thereby improving the penetration of the water-based ink into the paper, is already known (see Japanese Laid-Open Publication No. 2001-302955).

However, in water-based inks, a thickener is normally used to ensure a certain initial viscosity, but because the evaporation of the water that constitutes the ink is relatively fast on direct exposure to the atmosphere, if the ink is left exposed within an open system inside the printing machine, then evaporation of the water causes the viscosity of the ink to become overly high, which can cause considerable problems, including blurring of the printed image when printing is restarted after a lengthy period, and a requirement to clean the machine after printing. In order to overcome these problems, methods in which water evaporation prevention agents are added to the ink are also being tested, but further improvements are still required.

### SUMMARY OF THE INVENTION

The present invention relates to a water-based ink for stencil printing that comprises a copolymer (hereafter referred to as “copolymer A”) of an unsaturated carboxylic acid as a first monomer, and a second monomer selected from the group consisting of vinyl amide-based monomers, vinyl ether-based monomers, and hydroxyl group-containing (meth)acrylate ester-based monomers.

Another aspect of the present invention relates to a stencil printing method that uses a water-based ink for stencil printing according to the above aspect of the present invention.

### DETAILED DESCRIPTION OF THE EMBODIMENTS

A water-based ink for stencil printing (hereafter, the term “water-based ink for stencil printing” is abbreviated as simply “ink”) according to the present invention comprises water, a water-soluble organic solvent, a colorant, and a copolymer A of an unsaturated carboxylic acid as a first monomer, and a second monomer selected from the group consisting of vinyl amide-based monomers, vinyl ether-based monomers, and hydroxyl group-containing (meth)acrylate ester-based monomers, as a thickener. The copolymer A may be a random, alternate, block, or graft copolymer. Furthermore, the structure of the molecular chain may be either a straight chain structure, or a cross-linked structure containing cross-linking within the molecule.

The unsaturated carboxylic acid of the first monomer is preferably an electrolyte monomer that exhibits high solubility in water and provides a powerful thickening effect when converted to a copolymer.

Specifically, one or more unsaturated carboxylic acids represented by a general formula (1) shown below can be favorably used. 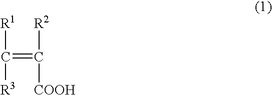
(wherein, R¹, R², and R³ each represent, independently, H, CH₃, or (CH₂)ₙCOOH (wherein, n is either 0 or 1)). The use of one or more unsaturated carboxylic acids selected from the group consisting of acrylic acid, methacrylic acid, maleic anhydride, maleic acid, fumaric acid, crotonic acid, and itaconic acid is even more preferred.

These unsaturated carboxylic acids also include structures in which the carboxyl group is in the form of a water-soluble salt, such as sodium salts, potassium salts, ammonium salts, and triethanolamine salts.

The polymerizable compound of the second monomer is a water-soluble nonelectrolyte monomer, and employs one or more monomers selected from the group consisting of vinyl amide-based monomers, vinyl ether-based monomers, and hydroxyl group-containing (meth)acrylate ester-based monomers.

Specific examples of suitable vinyl amide-based monomers include (meth)acrylamides such as (meth)acrylamide, methyl (meth)acrylamide, dimethyl (meth)acrylamide, ethyl (meth)acrylamide, diethyl (meth)acrylamide, dimethylaminopropyl (meth)acrylamide, isopropyl (meth)acrylamide, and hydroxypropyl (meth)acrylamide, as well as derivatives thereof; vinylpyrrolidones such as vinylpyrrolidone and isopropenylpyrrolidone, as well as derivatives thereof; vinylcaprolactams such as vinylcaprolactam and isopropenylcaprolactam, as well as derivatives thereof; and vinylacetamides. In this description, the terms (meth)acrylic acid, (meth)acrylamide, and (meth)acrylate refer to both acrylic acid and methacrylic acid, or to the associated derivatives thereof.

Examples of suitable vinyl ether-based monomers include methyl vinyl ether and hydroxymethyl vinyl ether.

Examples of suitable hydroxyl group-containing (meth)acrylate ester-based monomers include hydroxyethyl (meth)acrylate, hydroxypropyl (meth)acrylate, ethylene glycol (meth)acrylate, diethylene glycol (meth)acrylate, polyethylene glycol (meth)acrylate, and glycosyloxyethyl (meth)acrylate.

The copolymer A comprising a first monomer and second monomer described above can be used either alone, or in combinations of a plurality of different copolymers.

In a particularly preferred embodiment, the thickener employs one or more copolymers selected from the group consisting of copolymers of acrylic acid and acrylamide, copolymers of maleic anhydride and methyl vinyl ether, copolymers of acrylic acid and vinylpyrrolidone, and copolymers of acrylic acid and vinylacetamide (each of these copolymers may also exist in the form of a salt).

The blend quantity of the copolymer A within the ink is preferably at least 0.05% by weight in order to impart an appropriate level of viscosity, but is preferably no more than 5% by weight in order to ensure favorable transferability of the ink to the paper. Blend quantities within a range from 0.1 to 3% by weight are particularly desirable.

In the copolymer A, in those cases where the carboxyl groups do not exist in salt form, a base is also added. If the carboxyl groups are in salt form, then a base need not be added. Examples of suitable bases include inorganic bases such as potassium hydroxide, ammonium hydroxide, and sodium hydroxide, as well as low molecular weight amines, alkanolamines, triethanolamine, and low concentration ammonia.

Generally, once a stencil printing ink has been set in the printing machine, that is, removed from the ink bottle and transferred into the printing drum, the ink sits in an open system inside the printing machine. This allows the water in the ink to evaporate, and depending on the conditions, the quantity of water within the ink typically reduces to a value of several percent within a period of a few days (the residual several percent of water is retained by the water-soluble organic solvent and remains within the ink). Accordingly, it is thought that because the main solvent changes from being water (that contains some water-soluble organic solvent) to being a water-soluble organic solvent (that contains some retained water), the stability of the ink is lost, causing separation of the organic solvent (solvent discharge).

By using a copolymer A described above, a powerful thickening effect is maintained even when the solvent is predominantly water, and the desired level of viscosity can be achieved through addition of a small quantity of the copolymer. Moreover, the copolymer A is able to maintain its dissolved state even within the water-soluble organic solvent that is generated following evaporation of the water, meaning solvent discharge can be prevented even after the ink has been sitting in an open system.

In a preferred embodiment, this ink may also comprise, if required, one or more other water-soluble polymer-based thickeners or clay mineral-based thickeners, in addition to the aforementioned copolymer A.

Examples of these optional other water-soluble polymer-based thickeners include plant-based natural polymers such as gum arabic, carageenan, guar gum, locust bean gum, pectin, tragacanth gum, corn starch, konjac mannan, and agar; microbial natural polymers such as pullulan, xanthan gum, and dextrin; animal-based natural polymers such as gelatin, casein, and animal glue; cellulose-based semisynthetic polymers such as ethylcellulose, carboxymethylcellulose, hydroxyethylcellulose, hydroxypropylcellulose, methylcellulose, and hydroxypropylmethylcellulose; starch-based semisynthetic polymers such as hydroxyethyl starch, sodium carboxymethyl starch, and cyclodextrin; alginate-based semisynthetic polymers such as sodium alginate and propylene glycol alginate; sodium hyaluronate; and synthetic polymers such as polyacrylic acid, polymethacrylic acid, polycrotonic acid, polyitaconic acid, polymaleic acid, polyfumaric acid, acrylic acid-methacrylic acid copolymers, acrylic acid-itaconic acid copolymers, acrylic acid-maleic acid copolymers, acrylic acid-acrylate ester copolymers, acrylic acid-methacrylate ester copolymers, acrylic acid-sulfonic acid-based monomer copolymers, polyvinylpyrrolidone, polyvinyl alcohol, polyvinyl methyl ether, poly-N-vinylacetamide, polyacrylamide, polyethylene oxide, polyethyleneimine, and polyurethane.

Examples of clay mineral-based thickeners include smectite-based clay minerals such as montmorillonite, hectorite, and saponite.

The blend quantity of these optional other thickeners within the ink is preferably no more than 10% by weight, even more preferably no more than 5% by weight, and most preferably 2% by weight or less.

Depending on the nature of the compound and the quantity added, the water-soluble polymers listed above as possible thickeners may also be used for purposes other than thickening the ink, including as fixing agents for fixing colorants to the printing paper. Furthermore, in those cases where pigments are used as colorants, the water-soluble polymers may also be used as pigment dispersing agents.

From the viewpoint of improving the drying characteristics of the printed material, water preferably accounts for at least 50% by weight, and even more preferably 65% by weight or more, of the ink. The water contained within the ink can evaporate into the atmosphere immediately following printing. In addition, it is thought that by forcing the ink to penetrate into the gaps between the fibers of the printing paper during printing, the contact surface area between the ink and the air expands rapidly within the interior of the printing paper, further improving the evaporation rate of the water, and as a result, increasing the quantity of water further improves the drying characteristics of the printed material. Although there are no particular restrictions on the upper limit for the blend quantity of the water, the quantity is preferably set to ensure a favorable balance with the other components of the ink.

The water-soluble organic solvent is a liquid at room temperature, and is soluble in water. Suitable examples include lower alcohols such as methanol, ethanol, 1-propanol, isopropanol, 1-butanol, 2-butanol, isobutanol, and 2-methyl-2-propanol; glycols such as ethylene glycol, diethylene glycol, triethylene glycol, tetraethylene glycol, pentaethylene glycol, propylene glycol, dipropylene glycol, and tripropylene glycol; glycerol; acetins (monoacetin, diacetin, and triacetin); glycol derivatives such as triethylene glycol monomethyl ether, triethylene glycol monoethyl ether, triethylene glycol monopropyl ether, triethylene glycol monobutyl ether, tetraethylene glycol monomethyl ether, tetraethylene glycol monoethyl ether, tetraethylene glycol dimethyl ether, and tetraethylene glycol diethyl ether; as well as triethanolamine, β-thiodiglycol, and sulfolane. Low molecular weight polyalkylene glycols, including polyethylene glycol with an average molecular weight within a range from 190 to 630, such as an average molecular weight of 200, 300, 400, or 600, polypropylene glycol diol with an average molecular weight within a range from 200 to 600, such as an average molecular weight of 400, and polypropylene glycol triol with an average molecular weight within a range from 250 to 800, such as an average molecular weight of 300 or 700, can also be used. These water-soluble organic solvents can be used either alone, or in combinations of two or more different solvents.

Of the above water-soluble organic solvents, a solvent comprising one or more solvents selected from the group consisting of diethylene glycol, triethylene glycol, tetraethylene glycol, and polyethylene glycol with an average molecular weight of 190 to 210 is preferred. By using this type of water-soluble organic solvent with the copolymer A described above, the degree of variation in the ink viscosity, relative to the initial ink viscosity, following a period where the ink has sat unused can be reduced, even for those cases where the ink is left sitting in the open air and the water evaporates, causing a reduction in the total volume of solvent within the ink.

For the same reason, the use of a combination of a first solvent comprising one or more solvents selected from the group consisting of glycerol, ethylene glycol, and propylene glycol, and a second solvent comprising one or more solvents selected from the group consisting of pentaethylene glycol, β-thiodiglycol, and polyethylene glycol alkyl ethers (R₁O(CH₂CH₂O)ₙR₂; wherein R₁ represents an alkyl group of 1 to 4 carbon atoms, R₂ represents either H or an alkyl group of 1 or 2 carbon atoms, and 3≦n≦5) is also desirable. Specific examples of suitable polyethylene glycol alkyl ethers include triethylene glycol monoethyl ether, triethylene glycol monopropyl ether, triethylene glycol monobutyl ether, triethylene glycol diethyl ether, tetraethylene glycol monoethyl ether, tetraethylene glycol monopropyl ether, tetraethylene glycol monobutyl ether, and tetraethylene glycol diethyl ether.

The quantity of the water-soluble organic solvent within the ink is preferably at least 5% by weight, and even more preferably 10% by weight or greater. Although there are no particular restrictions on the upper limit for this quantity, in order to avoid image show through, the quantity is preferably no more than approximately 45% by weight, and even more preferably no more than approximately 35% by weight. By incorporating at least 5% by weight of a water-soluble organic solvent with a higher boiling point than water, and preferably a boiling point of at least 150° C., drying of the perforated portions of the stencil master during printing can be effectively prevented.

The colorant can use either pigments or dyes, or a combination of two or more such colorants. Suitable pigments include organic pigments such as azo-based pigments, phthalocyanine-based pigments, dye-based pigments, condensed polycyclic pigments, nitro-based pigments, and nitroso-based pigments (such as brilliant carmine 6B, lake red C, Watchung red, disazo yellow, Hansa yellow, phthalocyanine blue, phthalocyanine green, alkali blue, and aniline black); inorganic pigments, including metals such as cobalt, iron, chrome, copper, zinc, lead, titanium, vanadium, manganese, and nickel, as well as metal oxides, metal sulfides, yellow ocher, ultramarine, and iron blue pigments; and carbon blacks such as furnace carbon black, lamp black, acetylene black, and channel black. Suitable dyes include those basic dyes, acid dyes, direct dyes, soluble vat dyes, acid mordant dyes, mordant dyes, reactive dyes, vat dyes, and sulfide dyes that are water soluble, as well as those dyes that have been converted to a water-soluble form through reduction or the like. Either pigments and/or dyes can be used as the colorant, but the use of pigments is preferred, as they enable production of an ink that exhibits minimal bleeding or image show through, and excellent weather resistance.

The quantity of colorant within the ink is preferably within a range from 1 to 20% by weight, and even more preferably from 3 to 10% by weight. In order to maximize the print density of the printed material, the colorant quantity is preferably at least 5% by weight.

In a preferred embodiment, the ink may also include suitable quantities of pigment dispersing agents, fixing agents, antifoaming agents, surface tension reduction agents, pH regulators, antioxidants, and preservatives, in addition to the components described above.

An alkali-soluble resin may also be added to the ink as a fixing agent for improving the fixation of the colorant to the print target such as the printing paper. In those cases where a pigment is used as the colorant, an alkali-soluble resin can also be used as a pigment dispersing agent.

Examples of suitable alkali-soluble resins include styrene-(meth)acrylic acid copolymers, styrene-α-methylstyrene-(meth)acrylic acid copolymers, styrene-(meth)acrylate ester-(meth)acrylic acid copolymers, styrene-maleic anhydride copolymers, vinylnaphthalene-(meth)acrylic acid copolymers, vinylnaphthalene-maleic acid copolymers, isobutylene-maleic anhydride copolymers, (meth)acrylate ester-(meth)acrylic acid copolymers, and acrylate ester-methacrylate ester-(meth)acrylic acid copolymers. A combination of two or more of these resins may also be used. These alkali-soluble resins can be neutralized and converted to a water-soluble form using a suitable alkali, including an alkali metal hydroxide such as sodium hydroxide or potassium hydroxide, ammonia water, or an alkanolamine such as triethanolamine.

If a large quantity of alkali-soluble resin is added, then there is a danger of interfering with the printing performance of the printing machine following a period of non-use, and consequently the quantity of alkali-soluble resin within the ink, calculated as a solid fraction percentage, is preferably no more than 5% by weight, and even more preferably 3% by weight or less.

An oil-in-water (O/W) resin emulsion can also be incorporated within the ink, and used as a fixing agent for fixing the colorant to the printing paper or the like that functions as the print target (the print medium). In those cases where a pigment is used as the colorant, this resin emulsion can also be used as a pigment dispersing agent.

Examples of suitable oil-in-water (O/W) resin emulsions include emulsions of polyvinyl acetate, ethylene-vinyl acetate copolymers, vinyl acetate-(meth)acrylate ester copolymers, poly(meth)acrylate, polystyrene, styrene-(meth)acrylate ester copolymers, styrene-butadiene copolymers, vinylidene chloride-(meth)acrylate ester copolymers, polyvinyl chloride, vinyl chloride-vinyl acetate copolymers, and polyurethane and the like. Combinations of two or more of these emulsions may also be used.

If a large quantity of resin emulsion is added, then there is a danger of interfering with the printing performance of the printing machine following a period of non-use, and consequently the quantity of resin emulsion within the ink, calculated as a solid fraction percentage, is preferably no more than 5% by weight, and even more preferably 2% by weight or less.

Extender pigments may also be added to the ink to improve the image quality of the printed material. Examples of suitable extender pigments include white clay, talc, clay, diatomaceous earth, calcium carbonate, barium carbonate, barium sulfate, alumina white, silica, kaolin, mica, and aluminum hydroxide, and combinations of two or more of these extender pigments may also be used.

If a large quantity of extender pigment is added, then there is a danger of inhibiting the fixation of the colorant to the print target, and interfering with the printing performance of the printing machine following a period of non-use, and consequently the quantity of extender pigment is preferably no more than 5% by weight, and even more preferably 2% by weight or less.

In addition, anionic surfactants, cationic surfactants, amphoteric surfactants, nonionic surfactants, or polymer-based, silicone-based or fluorine-based surfactants may also be added to the ink as pigment dispersing agents, antifoaming agents, or surface tension reduction agents or the like.

An electrolyte may also be added to the ink to allow regulation of the ink viscosity or pH. Examples of suitable electrolytes include sodium sulfate, potassium hydrogenphosphate, sodium citrate, potassium tartrate, and sodium borate, and combinations of two or more of these electrolytes may also be used. Other materials such as sulfuric acid, nitric acid, acetic acid, sodium hydroxide, potassium hydroxide, ammonium hydroxide, and triethanolamine and the like may also be used in the ink as thickening assistants or pH regulators.

By adding an antioxidant, oxidation of the ink components can be prevented, and the stability of the ink can be improved. Examples of suitable antioxidants include L-ascorbic acid, sodium L-ascorbate, sodium isoascorbate, potassium sulfite, sodium sulfite, sodium thiosulfate, sodium dithionite, and sodium pyrosulfite.

By adding a preservative, degradation of the ink can be prevented, enabling the storage stability to be improved. Examples of suitable preservatives include isothiazolone-based preservatives such as 5-chloro-2-methyl-4-isothiazolin-3-one, 2-methyl-4-isothiazolin-3-one, 2-n-octyl-4-isothiazolin-3-one, and 1,2-benzoisothiazolin-3-one; triazine-based preservatives such as hexahydro-1,3,5-tris(2-hydroxyethyl)-s-triazine; pyridine or qionoline-based preservatives such as sodium 2-pyridinethiol-1-oxide and 8-oxyquinoline; dithiocarbamate-based preservatives such as sodium dimethyldithiocarbamate; organobromine-based preservatives such as 2,2-dibromo-3-nitrilopropionamide, 2-bromo-2-nitro-1,3-propanediol, 2,2-dibromo-2-nitroethanol, and 1,2-dibromo-2,4-dicyanobutane; as well as methyl p-hydroxybenzoate, ethyl p-hydroxybenzoate, potassium sorbate, sodium dehydroacetate, and salicylic acid.

The ink can be produced by mixing the water, the water-soluble organic solvent, the colorant, and the aforementioned copolymer A, together with any of the other optional components described above as desired. For example, a portion of the water, the pigment, and the pigment dispersing agent is mixed together, and a dispersion device such as a ball mill or beads mill is used to disperse the pigment, while the remainder of the water, the thickener, and the water-soluble organic solvent are also mixed together, before the two separate mixtures are then combined and mixed.

The most appropriate range for the ink viscosity varies depending on factors such as the printing pressure of the printing apparatus, but is typically within a range from approximately 0.5 to approximately 20 Pa·s (the viscosity is measured at 20° C., using a shear rate of 100/s), and (pseudo) plastic flow characteristics are ideal for stencil printing.

A stencil printing method according to the present invention is conducted using the ink according to the present invention described above. Specifically, the method comprises: preparing a stencil master; and pressing the produced stencil master and a print target together, thereby causing the ink of the present invention to pass through the perforated portions of the stencil master and onto the print target.

There are no particular restrictions on the printing machine used, although because of their superior operability, digital stencil printing machines are preferred.

### EXAMPLES

As follows is a more detailed description of the present invention using a series of examples, although the present invention is in no way limited by these examples. In the following description, the units “% by weight” are abbreviated simply as “%”.

### Example 1

5.0% of carbon black (CF9, manufactured by Mitsubishi Chemical Corporation) as a colorant, 1.0% of hexaglyceryl monolaurate (Hexaglyn 1-L, manufactured by Nikko Chemicals Co., Ltd.) as a pigment dispersing agent, and 19.0% of ion exchange water were mixed together, and were then dispersed thoroughly using a beads mill, thus yielding a pigment dispersion. 1.0% of a copolymer of sodium acrylate and acrylamide (Rheogic 835H, manufactured by Nihon Junyaku Co., Ltd.) as a thickener was dissolved in 14.0% of ion exchange water, and to the resulting solution were added 25.0% of the previously prepared pigment dispersion, 25.0% of diethylene glycol as a water-soluble organic solvent, and the remaining quantity of ion exchange water (35.0%), and the resulting combination was then mixed thoroughly, yielding an ink of the example 1.

### Examples 2 to 8

With the exception of using the blend ratios shown in Table 1, inks for each of the examples were prepared in the same manner as the example 1. In Table 1, the acrylic acid-vinylpyrrolidone copolymer refers to Acrylidone ACP-1005, manufactured by ISP Co., Ltd., the maleic anhydride-methyl vinyl ether copolymer refers to Stabileze QM, manufactured by ISP Co., Ltd., and the acrylic acid-vinylacetamide copolymer refers to GE-167, manufactured by Showa Denko K.K. Furthermore, polyethylene glycol #200 refers to a reagent with an average molecular weight of 200, manufactured by Wako Pure Chemical Industries Ltd.

### Comparative Examples 1 to 4

With the exception of using the blend ratios shown in Table 2, inks for each of the comparative examples were prepared in the same manner as the example 1. In Table 2, the sodium polyacrylate refers to Rheogic 250H, manufactured by Nihon Junyaku Co., Ltd., and the acrylic acid-alkyl methacrylate copolymer refers to Carbopol ETD 2020, manufactured by BF Goodrich Company.

Using each of the inks prepared in the above examples and comparative examples, printing was conducted onto printing paper (Riso lightweight paper, manufactured by Riso Kagaku Corporation) using a stencil printing machine (RISO RP3700, manufactured by Riso Kagaku Corporation), and following printing, the machine was left to stand for 15 hours in an environment at 23° C. and 50% RH. Subsequently, a newly prepared stencil was wound onto the printing drum of the printing machine, printing was recommenced, and the quality of the thus produced print image was inspected. The quality of the image at printing startup was evaluated using the following criteria. A: a non-blurred image was obtained within 20 copies, B: a non-blurred image was obtained after 20 to 100 copies, C: even after printing 100 copies, the image remained blurred.

The results are shown in Table 1 and Table 2.

TABLE 1

| | | % by weight | | | | | | | |
|---|---|---|---|---|---|---|---|---|---|
| | | Example | | | | | | | |
| Blend ratio | | 1 | 2 | 3 | 4 | 5 | 6 | 7 | 8 |
| Colorant | Carbon black | 5.0 | 5.0 | 5.0 | 5.0 | 5.0 | 5.0 | 5.0 | 5.0 |
| Pigment | Hexaglyceryl monolaurate | 1.0 | 1.0 | 1.0 | 1.0 | 1.0 | 1.0 | 1.0 | 1.0 |
| dispersing | | | | | | | | | |
| agent | | | | | | | | | |
| Thickener | Sodium acrylate-acrylamide | 1.0 | 1.0 | 1.0 | — | — | — | 1.0 | — |
| | copolymer | | | | | | | | |
| | Acrylic acid- | — | — | — | 0.5 | — | — | — | — |
| | vinylpyrrolidone copolymer | | | | | | | | |
| | Maleic anhydride-methyl | — | — | — | — | 0.5 | — | — | 0.5 |
| | vinyl ether copolymer | | | | | | | | |
| | Acrylic acid- | — | — | — | — | — | 1.0 | — | — |
| | vinylacetamide copolymer | | | | | | | | |
| Water-soluble | Diethylene glycol | 25.0 | — | — | — | — | — | — | — |
| organic | Triethylene glycol | — | 25.0 | — | 25.0 | — | — | — | — |
| solvent | Tetraethylene glycol | — | — | — | — | 25.0 | — | — | — |
| | Polyethylene glycol #200 | — | — | — | — | — | 25.0 | — | — |
| | Propylene glycol | — | — | 25.0 | — | — | — | 15.0 | — |
| | Glycerol | — | — | — | — | — | — | — | 15.0 |
| | Triethylene glycol | — | — | — | — | — | — | — | 10.0 |
| | monobutyl ether | | | | | | | | |
| | β-thiodiglycol | — | — | — | — | — | — | 10.0 | — |
| Neutralizing | Sodium hydroxide | — | — | — | 0.2 | 0.2 | 0.4 | — | 0.2 |
| agent | | | | | | | | | |
| Water | Ion exchange water | 68.0 | 68.0 | 68.0 | 68.3 | 68.3 | 67.6 | 68.0 | 68.3 |
| Evaluation | Image quality at printing | A | A | B | A | A | A | A | A |
| | startup | | | | | | | | |

TABLE 2

| | | % by weight | | | |
|---|---|---|---|---|---|
| | | Comparative Example | | | |
| Blend ratio | | 1 | 2 | 3 | 4 |
| Colorant | Carbon black | 5.0 | 5.0 | 5.0 | 5.0 |
| Pigment dis- | Hexaglyceryl | 1.0 | 1.0 | 1.0 | 1.0 |
| persing agent | monolaurate | | | | |
| Thickener | Sodium polyacrylate | 1.0 | 1.0 | — | 1.0 |
| | Acrylic acid-alkyl | — | — | 0.5 | — |
| | methacrylate copolymer | | | | |
| | Propylene glycol | 25.0 | — | — | 15.0 |
| Water-soluble | Diethylene glycol | — | 25.0 | — | — |
| organic solvent | Triethylene glycol | — | — | 25.0 | — |
| | β-thiodiglycol | — | — | — | 10.0 |
| Neutralizing | Sodium hydroxide | — | — | 0.2 | — |
| agent | | | | | |
| Water | Ion exchange water | 68.0 | 68.0 | 68.3 | 68.0 |
| Evaluation | Image quality at | C | C | C | C |
| | printing startup | | | | |

With the inks from the examples 1, 2, and 4 to 8, even after evaporation of the water following standing for 15 hours, no solvent discharge occurred, and increases in the ink viscosity were able to be suppressed, meaning within a dozen or so copies of recommencing printing, an image of the same quality as that observed prior to the stand down period was able to be obtained. With the ink of the example 3, no solvent discharge occurred following evaporation of the water, but because the viscosity of the ink increased, a deterioration in the image density was observed on recommencing printing, although once several dozen copies had been printed, an image of the same quality as that observed prior to the stand down period was able to be obtained. Furthermore, investigation of the drying characteristics of the printed materials obtained in each of the examples revealed that when a printed page was touched 10 seconds after having been printed, the ink did not transfer to the finger, indicating excellent drying characteristics in each case.

In contrast, with the inks from the comparative examples 1 to 4, evaporation of the water on standing caused solvent discharge within the ink, meaning even after 100 copies had been printed on recommencing printing, the image remained completely unformed in some regions, and restoring the entire image proved impossible. It is thought that this observation is due to the solvent discharge generating regions of extremely high solid fraction concentration within the ink inside the printing drum, which means the ink viscosity within those regions increases dramatically, causing a loss of fluidity, and making the ink unable to pass through certain areas of the stencil.

As is evident from the results described above, because an ink according to the present invention uses a copolymer A comprising specific first and second monomers as a thickener, separation of the organic solvent (solvent discharge) from an ink left sitting within an open system inside the printing machine is suppressed, enabling the stability of the ink to be retained. Accordingly, by using an ink of the present invention, the blurring of the printed image that occurs on recommencing printing after the printing machine has been sitting in an unused state can be eliminated quickly, and moreover, a printed material with excellent post-printing drying characteristics can also be produced.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A water-based ink for stencil printing, comprising a copolymer of an unsaturated carboxylic acid as a first monomer, and a second monomer selected from the group consisting of vinyl amide-based monomers, vinyl ether-based monomers, and hydroxyl group-containing (meth)acrylate ester-based monomers.

2. The water-based ink for stencil printing according to claim 1, wherein the first monomer comprises an unsaturated carboxylic acid represented by a general formula (1) shown below, or a salt thereof: 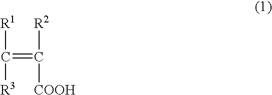
(wherein, R¹, R², and R³ each represent, independently, H, CH₃, or (CH₂)ₙCOOH (wherein, n is either 0 or 1)).

3. The water-based ink for stencil printing according to claim 2, wherein the first monomer comprises one or more unsaturated carboxylic acids selected from the group consisting of acrylic acid, methacrylic acid, maleic anhydride, maleic acid, fumaric acid, crotonic acid, and itaconic acid, or one or more salts thereof.

4. The water-based ink for stencil printing according to claim 1, wherein the second monomer comprises one or more polymerizable compounds selected from the group consisting of acrylamide, methacrylamide, alkyl vinyl ethers, vinylpyrrolidone, and vinylacetamide.

5. The water-based ink for stencil printing according to claim 1, wherein the copolymer comprises one or more copolymers selected from the group consisting of copolymers of acrylic acid and acrylamide, copolymers of maleic anhydride and methyl vinyl ether, copolymers of acrylic acid and vinylpyrrolidone, and copolymers of acrylic acid and vinylacetamide, or one or more salts thereof.

6. The water-based ink for stencil printing according to claim 1, further comprising one or more water-soluble organic solvents selected from the group consisting of diethylene glycol, triethylene glycol, tetraethylene glycol, and polyethylene glycols with an average molecular weight of 190 to 210.

7. The water-based ink for stencil printing according to claim 1, further comprising a first solvent comprising one or more solvents selected from the group consisting of glycerol, ethylene glycol, and propylene glycol, and a second solvent comprising one or more solvents selected from the group consisting of pentaethylene glycol, β-thiodiglycol, and polyethylene glycol alkyl ethers represented by a general formula R₁O(CH₂CH₂O)ₙR₂ (wherein R₁ represents an alkyl group of 1 to 4 carbon atoms, R₂ represents either H or an alkyl group of 1 or 2 carbon atoms, and 3≦n≦5).

8. A stencil printing method that uses the water-based ink for stencil printing according to claim 1.
